(19) United States
(12) Patent Application Publication
(10) Pub. No.: US 2009/0297721 A1
(43) Pub. Date: Dec. 3, 2009

(54) METHOD FOR COATING A SOLAR COLLECTOR

(75) Inventor: Stephen L. Goodstine, Windsor, CT (US)

Correspondence Address: Michaud-Duffy Group LLP, 306 Industrial Park Road, Suite 206, Middletown, CT, 06457, US

(73) Assignee: ALSTOM TECHNOLOGY LTD., Baden (CH)

(21) Appl. No.: 12/421,038

(22) Filed: Apr. 9, 2009

Related U.S. Application Data
(60) Provisional application No. 61/057,262, filed on May 30, 2008.

(51) Int. Cl. B05D 3/06

(52) U.S. Cl. 427/508

(57) ABSTRACT

A solar receiver 10 is coated by erecting the solar receiver, coating the erected solar receiver with a curable energy-absorptive coating; and concentrating solar energy 15 on the coated erected solar receiver 10 to cure the energy-absorptive coating.

### CROSS-REFERENCE TO RELATED APPLICATION

This application claims the benefit of U.S. provisional application No. 61/057,262 filed May 30, 2008, the contents of which is incorporated herein by reference in its entirety.

### FIELD OF THE INVENTION

The present disclosure relates generally to a method of coating a solar receiver, and more particularly to a method of coating a solar receiver situated to receive solar radiant energy from a solar energy concentrator system, e.g., a field of mirrors or heliostats.

### BACKGROUND

A solar boiler is a type of solar receiver which is used to absorb concentrated solar radiant energy to heat a transfer fluid and to produce a flow of steam from the fluid. The steam, in effect, contains the absorbed energy. The product steam, typically at high temperature and pressure, is then directed to drive a turbine of a steam turbine generator, thus converting the solar energy to electricity.

The surfaces of some solar receivers are coated with a material that exhibits a high solar spectrum absorption. Paint-like, commercial energy-absorptive coatings are available which will fulfill this function, e.g., PYROMARK 2500 (Pyromark is a registered trademark of Illinois Tool Works, Inc., Glenview, Ill. USA). Such coatings require a thermal curing cycle with various stages with temperature up to about 1,000° F. (538° C.) and the use of curing ovens. The painting/curing processes are carried out in a factory environment during fabrication of the solar receiver.

### SUMMARY OF THE INVENTION

According to aspects disclosed herein, there is provided a method of coating a solar receiver and/or components thereof, in situ. The method includes, subsequent to erecting the solar receiver, coating the solar receiver and/or portion thereof with a curable energy-absorptive coating. During operation of the solar receiver, solar energy is concentrated on the coated portion of the solar receiver, thereby curing the energy-absorptive coating.

According to other aspects disclosed herein, there is provided a method of repairing a damaged solar receiver and/or components in situ. This is accomplished by applying the curable energy-absorptive coating onto the damaged portion of the solar receiver, and during operation of the solar receiver, solar energy is concentrated on the portions of the solar receiver where the energy absorptive coating was applied, thereby curing it.

According to other aspects disclosed herein, there is provided a method of curing a curable energy absorptive material, in which curable energy-absorptive material is applied to the surface of a substrate to provide a curable energy-absorptive coating; and solar radiant energy is concentrated onto the curable energy-absorptive coating using a solar energy concentrator system, to cure the curable energy-absorptive coating.

The above described and other features are illustrated by the following figures and detailed description.

### BRIEF DESCRIPTION OF THE DRAWINGS

Referring now to the figures, which are exemplary embodiments, and wherein the like elements are numbered alike:

FIG. 1 is a schematic block diagram of a solar steam generation system including a solar receiver in accordance with one embodiment;

FIG. 1A is a plane view of a panel of the solar receiver of FIG. 1 formed of an array of tubes; and

FIG. 2 is a schematic block diagram of a solar steam generation system including a solar receiver in accordance with another embodiment.

### DETAILED DESCRIPTION OF PREFERRED EMBODIMENTS

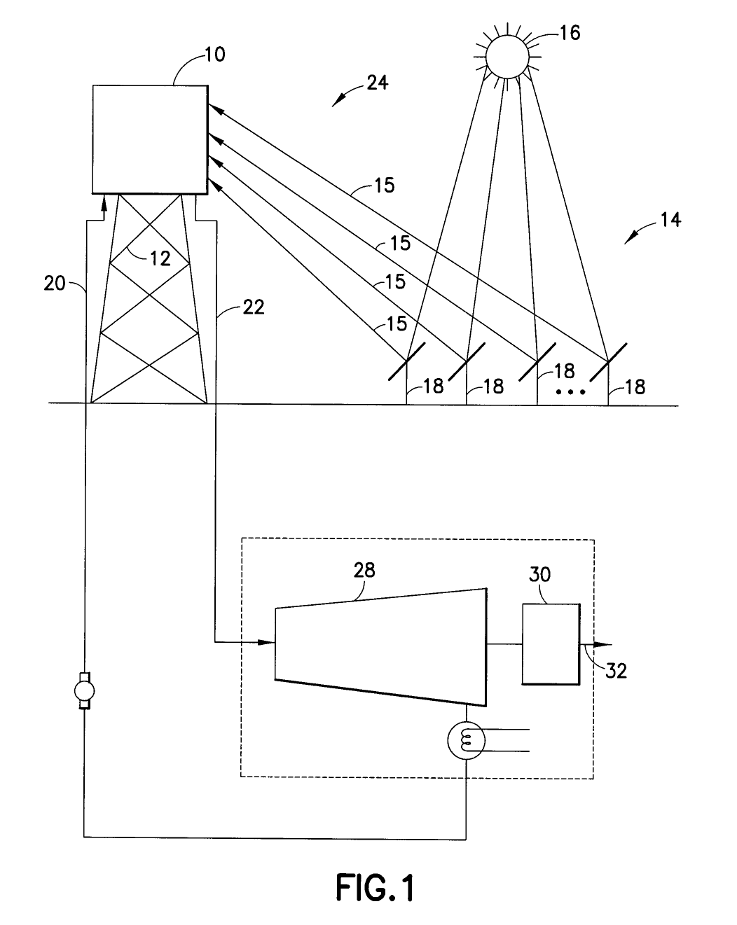

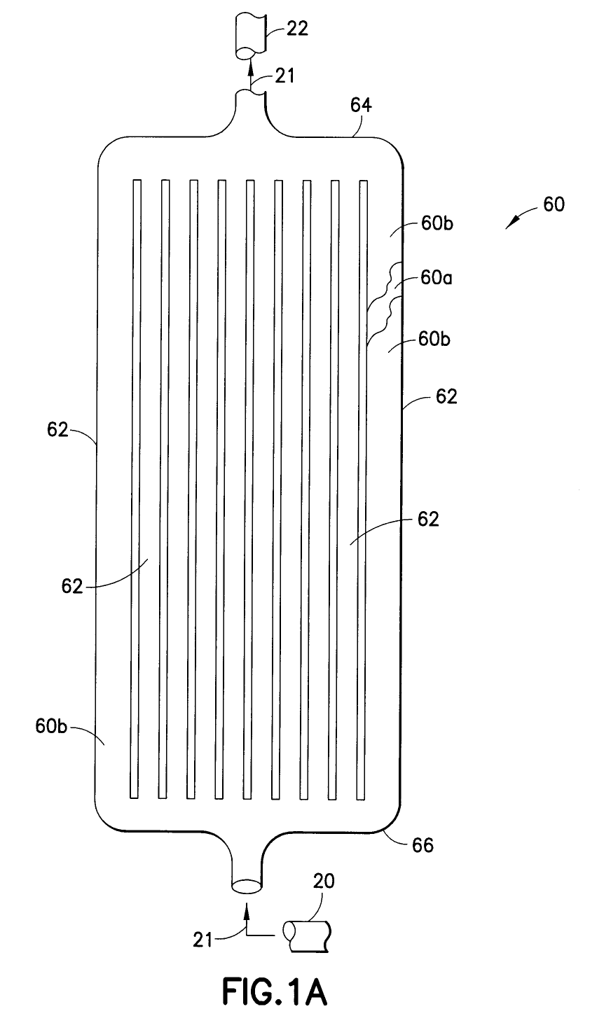

As shown in FIG. 1, a solar receiver 10 is erected on a tower 12 disposed near a solar energy concentrator system indicated generally at 14. The solar energy concentrator system 14 directs solar energy or solar radiation 15 from the sun 16 to the solar receiver 10. In the illustrated embodiment, the solar energy concentrator system 14 may comprise a plurality of solar collectors 18, such as mirrors or heliostats. In one embodiment, each solar collector 18 can be independently adjustable to track the relative position of the sun 16. For example, the solar collectors 18 can be arranged in arrays, whereby the solar collectors in each array are controlled separately or in combination with the other solar collectors of the array by one or more control devices (not shown) configured to detect and track the relative position of the sun 16. Thus, the solar collectors can periodically adjust according to the position of the sun 16 to reflect solar energy onto the solar receiver 10. This in turn results in heat being transferred to a transfer fluid 21 flowing through the solar receiver 10. The solar receiver 10 receives, via inlet conduit 20, the transfer fluid 21 to be heated, and the heated fluid 21 (or combination fluid, vapor or steam) is emitted from the solar receiver 10 via an outlet conduit 22.

In one embodiment, the solar receiver 10 includes at least one solar panel 60 comprising a plurality of tubes 62 attached to a first header 64 (e.g., an upper header/output manifold) and a second header 66 (e.g. a lower header/inlet manifold), shown in greater detail in FIG. 1A. The plurality of tubes 62 are coupled to the inlet conduit 20 to receive the transfer fluid 21 and to the outlet conduit 22 to pass the heated fluid 21 (fluid, vapor or steam) from the solar receiver 10 by the headers 66 and 64, respectively. It should be appreciated that the solar receiver 10 may include a plurality of the solar panels 60. A portion 60a of the panel 60 includes an energy-absorptive coating 60b applied in an uncured form after the panel 60 and/or the receiver 10 is assembled and erected on the tower 12. The uncured energy-absorptive coating 60b may be sprayed or otherwise painted onto the portion 60a of the panel 60 (e.g., an exterior surface of the tubes 62) and then cured in place by the application of solar energy 15 provided by the solar energy concentrator system 14 appropriately controlled to provide a heat curing cycle as may be specified by the energy-absorptive coating manufacturer. In one embodiment, the silicone-based energy-absorptive coating 60b can have a solar absorptivity of about 0.95. One such coating having particular utility in the above-described system is referred to as Pyromark 2500, but the invention is not limited in this regard, and in other embodiments, any other suitable energy-absorptive coating may be used. In one embodiment, the heat curing cycle may comprise heating the coating to about 1,000° F. (538° C.). Regarding the above-described Pyromark 2500 material, the manufacturer recommends that following application, the material be allowed to air dry overnight and then be cured for two hours at 480° F. For maximum resistance to heat shock, slowly bring the material to 1,000° F. over a one hour period. The energy-absorptive coating 60b applied as described herein may be the first energy-absorptive coating applied to the portion 60a of the panel 60, or it may be a remedial energy-absorptive coating applied over an energy-absorptive coating that was previously applied in a factory according to the prior art and that was damaged during erection of the solar receiver 10 and/or installation of the panel 60. Alternatively, a remedial energy-absorptive coating may be applied over a previously applied energy-absorptive coating that has deteriorated over time and/or during use of the solar receiver 10.

In one embodiment, the solar receiver 10 is part of a solar-powered electricity generation system indicated generally at 24, wherein the fluid 21 heated by the solar receiver 10 is water and the solar receiver 10 is a boiler that produces high energy steam for a steam turbine generator 26 in fluid communication (via the outlet conduit 22) with the receiver 10. The steam turbine generator 26 includes a steam turbine 28 that is driven by the steam passed from the outlet conduit 22 to turn an outlet shaft 29 which powers a generator 30 to produce electricity 32. Water returns from the steam turbine generator 26 to the solar receiver 10 via the inlet piping 20. In one embodiment, a pump 31 drives the water/transfer fluid back to the solar receiver 10 via the inlet conduit 20.

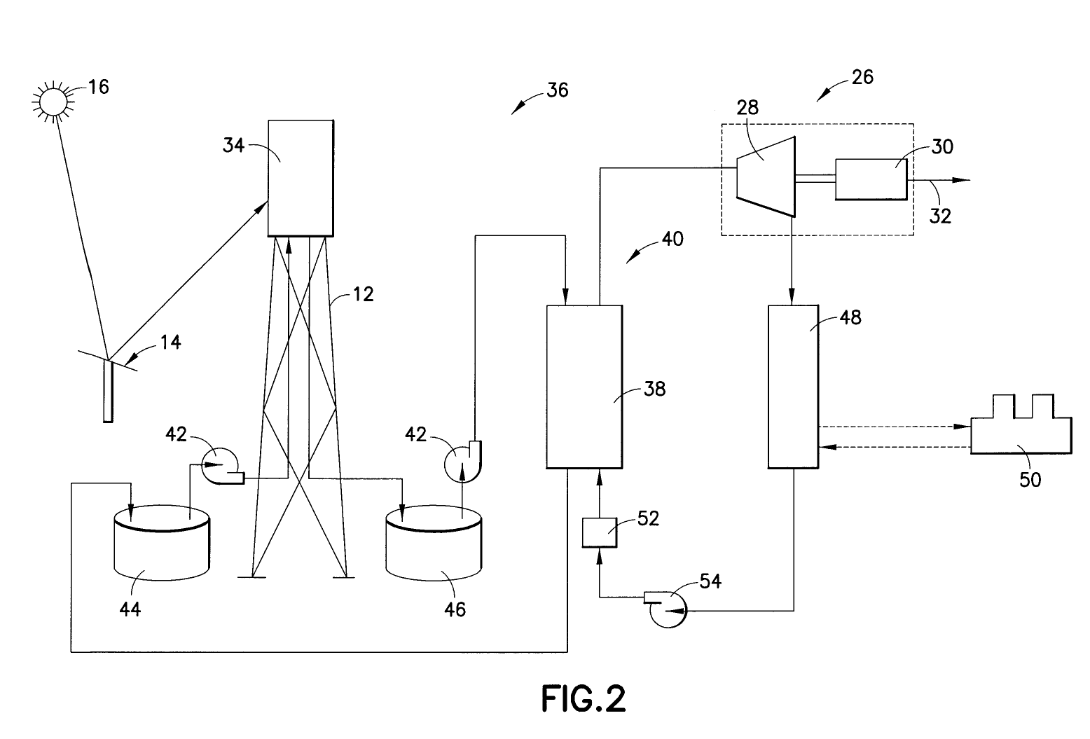

In another embodiment, a solar receiver 34 shown in FIG. 2 is erected on the tower 12 to be part of a solar-powered electricity generation system indicated generally at 36. The solar-powered electricity generation system 36 includes a solar energy concentrator system 14 which reflects the solar radiant energy 15 of the sun 16 onto the solar receiver 34. The solar receiver 34 includes serpentine tubes (e.g., one or more panels 60) that receive a heat transfer fluid (e.g., fluid 21) therethrough. The solar receiver 34 (e.g., the panel 60) is coated with an uncured energy-absorptive coating after being erected on the tower 12, and the uncured energy-absorptive coating is cured using the solar energy concentrator system 14 as described herein. The heat transfer fluid 21 is delivered from the tower 12 to a steam generator 38, in which thermal energy is exchanged from the heat transfer fluid 21 to water circulating in a separate fluid circuit 40. The heat transfer fluid 21 is thereby cooled in the steam generator 38 and can then be recirculated back to the solar receiver 34 for reheating. Pumps 42 can be used to circulate the heat transfer fluid 21, and tanks 44, 46 can be used to store the heat transfer fluid before and after heating by the solar receiver 34. Various types of heat transfer fluids can be used with the solar-powered electricity generation system 36. In one embodiment, for example, the heat transfer fluid 21 may be a molten salt such as a nitrate salt including about 60% sodium nitrate and about 40% potassium nitrate. Such a nitrate salt is generally useful in a temperature range of about 450° F. to 1100° F. (233° C. to about 593° C.), within which the nitrate salt generally exists as a single phase, i.e., a liquid, such that density of the fluid is substantially uniform throughout the operation of the electricity generation system 36. Alternative heat transfer fluids 21 include other liquid salts as well as oils and other fluids. The heat transfer fluids can be selected according to the desired and anticipated temperature variation of the fluid in the electricity generation system 36.

The water heated in the steam generator 38 forms steam that is circulated to the steam turbine which powers the generator 30 to produce electricity 32. As shown in FIG. 2, the steam can be passed through a condenser 48 that, in conjunction with a cooling tower 50, condenses the steam to form hot water that is heated in a preheater 52 and is circulated back to the steam generator 38 by a pump 54.

As described herein, a curable energy-absorption coating is applied onto a solar receiver and/or components thereof, for example, a solar boiler, after the solar receiver is erected. As a result, the factory assembly process for the solar receiver and/or components is simplified and the operation of the solar receiver can be maintained more easily. Moreover, the curable energy-absorption coating may be applied or periodically reapplied to supplement or replace damaged or deteriorated coating on the solar receiver and components. Once reapplied, the coating is cured in place, as described herein. In another aspect, the invention is not limited to the use of solar radiant energy for curing a curable energy-absorptive coating on a solar receiver and/or components, and in other embodiments, the curable energy-absorptive coating may be applied onto any other substrate for which an energy-absorptive surface is desired, and the coating may be cured thereon by the use of solar radiant energy as described herein.

While the invention has been described with reference to various exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method of coating a solar receiver, the method comprising:
coating the solar receiver with a curable energy-absorptive coating; and
concentrating solar energy on the coated erected solar receiver to cure the curable energy-absorptive coating.

2. The method of claim 1, comprising coating the solar receiver while the solar receiver stands erected on a tower.

3. The method of claim 1, wherein concentrating solar energy includes concentrating solar energy using a solar energy concentrator system.

4. The method of claim 3, wherein the solar energy concentrator includes a plurality of mirrors, heliostats or a combination thereof.

5. The method of claim 1, comprising controlling the solar energy concentrator system to provide a heat curing cycle for the curable energy-absorptive coating.

6. A method of repairing a damaged solar receiver, comprising:
applying a curable energy-absorptive coating onto the damaged erected solar receiver; and
concentrating solar energy on the coated erected solar receiver to cure the energy absorptive coating.

7. The method of claim 6, comprising repairing the damaged solar receiver while the solar receiver is mounted on a tower.

8. The method of claim 6, wherein heating comprises concentrating solar radiant energy onto the curable energy-absorptive coating.

9. A method of curing a curable energy absorptive material, comprising:
applying curable energy-absorptive material to the surface of a substrate to provide a curable energy-absorptive coating; and
concentrating solar radiant energy onto the curable energy-absorptive coating using a solar energy concentrator system, to cure the curable energy-absorptive coating.

10. The method of claim 9, wherein the substrate comprises a solar receiver.
